(19) United States
(12) Patent Application Publication
(10) Pub. No.: US 2022/0394435 A1
(43) Pub. Date: Dec. 8, 2022

(54) SYSTEM AND METHOD FOR SHORT MESSAGE SERVICE (SMS) CONTENT CLASSIFICATION

(71) Applicant: REALNETWORKS, INC., Seattle, WA (US)

(72) Inventors: Mirko CORIC, Seattle, WA (US); Randy WARSHAW, Seattle, WA (US)

(21) Appl. No.: 17/770,016

(22) PCT Filed: Dec. 6, 2019
(86) PCT No.: PCT/US2019/065086

§ 371 Date: Apr. 18, 2022

(51) Int. Cl. H04W 4/14; H04L 45/00; G06N 3/04

(52) U.S. Cl. CPC H04W 4/14; H04L 45/46; G06N 3/0445

(57) ABSTRACT

Techniques are described herein for receiving and analyzing messages originating from one sender for distribution to a recipient. A plurality of messages are received from a sender, each of the plurality of messages includes metadata and content. A sender profile is generated for the sender based on an analysis of the metadata of each of the plurality of messages. Each respective message of the plurality of messages is classified as one of a plurality of categories based on a deep learning network analysis of the content of each respective message. A sender fingerprint is generated based on a machine learning analysis of the content of each respective message. A probability that the sender is a spammer is determined based on the sender profile, the message classifications, and the sender fingerprint. The sender is tagged based on the determined probability.

### TECHNICAL FIELD

The following disclosure relates generally to techniques for processing messages between sender and recipient, and in particular to the classification of messages for differentiated handling of messages having similar content or characteristics.

### BACKGROUND

### Description of the Related Art

The quantity of messages being sent within and between messaging platforms has risen steadily in the last several years, typically corresponding to a rise in a quantity of mobile device and other subscriber users, as well as a rise in the use of alternative types of such messages. For example, in addition to traditional user-to-user or peer-to-peer (“P2P”) textual (e.g., SMS) or multimedia (e.g., MMS) messages, increasing quantities of application-to-person (“A2P”) and machine-to-machine (“M2M”) messages are being transmitted within and between such messaging platforms. Moreover, despite numerous historical and ongoing attempts to identify and curtail non-authorized solicitations, unauthorized commercial messages, or “spam” messages also continue to proliferate.

When messages are transmitted from a sender on one messaging platform to one or more recipients on another messaging platform, the provision of messages between platforms may be performed by a messaging transport system. However, such messaging transport systems typically do not significantly differentiate between messages based on content—they simply route messages from one messaging platform to another.

### BRIEF SUMMARY

A method may be summarized as including receiving, by one or more computing systems, a plurality of messages from a sender, each of the plurality of messages includes metadata and content; generating, by the one or more computing systems, a sender profile for the sender based on an analysis of the metadata of each of the plurality of messages; classifying, by the one or more computing systems, each respective message of the plurality of messages as one of a plurality of categories based on a deep learning network analysis of the content of each respective message; generating, by the one or more computing systems, a sender fingerprint based on a machine learning analysis of the content of each respective message; determining, by the one or more computing systems, a probability that the sender is a spammer based on the sender profile, the message classifications, and the sender fingerprint; and tagging, by the one or more computing systems, the sender based on the determined probability.

The method may further include clustering, by the one or more computing systems, the plurality of messages into a plurality of clusters based on the content; and determining, by the one or more computing systems, whether one or more of the plurality of clusters is associated with a whitelisted or blacklisted cluster. Clustering the plurality of messages may include generating message feature vectors based on the content of each respective message; generating new message clusters based on the message feature vectors; and merging the new message clusters with a plurality of existing message clusters. Clustering the plurality of messages may include generating message feature vectors based on the content of each respective message; and employing a spatial partitioning tree using the message feature vectors to generate the plurality of clusters. Classifying the plurality of messages may include generating message feature vectors based on the content of each respective message; employing one or more convolution neural network layers on the message feature vectors; employing one or more long-short term memory layers on the message feature vectors; and employing one or more fully connected neural network layers on the message feature vectors to determine a category for each respective message. Generating the sender profile for the sender may include aggregating information obtained from the plurality of messages regarding the sender.

A non-transitory computer-readable medium having stored contents that, when executed by one or more computing systems, may cause the one or more computing systems to receive a plurality of messages from a sender, each of the plurality of messages includes metadata and content; generate a sender profile for the sender based on an analysis of the metadata of each of the plurality of messages; classify each respective message of the plurality of messages as one of a plurality of categories based on a deep learning network analysis of the content of each respective message; generate a sender fingerprint based on a machine learning analysis of the content of each respective message; determine a probability that the sender is a spammer based on the sender profile, the message classifications, and the sender fingerprint; and tag the sender based on the determined probability.

The stored contents may further cause the one or more computing systems to cluster the plurality of messages into a plurality of clusters based on the content; and determine whether one or more of the plurality of clusters is associated with a whitelisted or blacklisted cluster. To cluster the plurality of messages may include generate message feature vectors based on the content of each respective message; generate new message clusters based on the message feature vectors; and merge the new message clusters with a plurality of previous message clusters. To cluster the plurality of messages may include generate message feature vectors based on the content of each respective message; and employ a spatial partitioning tree using the message feature vectors to generate the plurality of clusters. To classify the plurality of messages may include generate message feature vectors based on the content of each respective message; employ one or more convolution neural network layers on the message feature vectors; employ one or more long-short term memory layers on the message feature vectors; and employ one or more fully connected neural network layers on the message feature vectors to determine a category for each respective message. To generate the sender profile for the sender may include aggregate information obtained from the plurality of messages regarding the sender.

A system may be summarized as including one or more processors; and at least one non-transitory memory, the non-transitory memory including instructions that, upon execution by at least one of the one or more processors, cause the system to receive a plurality of messages from a sender, each of the plurality of messages includes metadata and content; generate a sender profile for the sender based on an analysis of the metadata of each of the plurality of messages; classify each respective message of the plurality of messages as one of a plurality of categories based on a deep learning network analysis of the content of each respective message; generate a sender fingerprint based on a machine learning analysis of the content of each respective message; determine a probability that the sender is a spammer based on the sender profile, the message classifications, and the sender fingerprint; and tag the sender based on the determined probability.

The instructions may further cause the system to cluster the plurality of messages into a plurality of clusters based on the content; and determine whether one or more of the plurality of clusters is associated with a whitelisted or blacklisted cluster. To cluster the plurality of messages may include generate message feature vectors based on the content of each respective message; generate new message clusters based on the message feature vectors; and merge the new message clusters with a plurality of previous message clusters. To cluster the plurality of messages may include generate message feature vectors based on the content of each respective message; and employ a spatial partitioning tree using the message feature vectors to generate the plurality of clusters. To classify the plurality of messages may include generate message feature vectors based on the content of each respective message; employ one or more convolution neural network layers on the message feature vectors; employ one or more long-short term memory layers on the message feature vectors; and employ one or more fully connected neural network layers on the message feature vectors to determine a category for each respective message. To generate the sender profile for the sender may include aggregate information obtained from the plurality of messages regarding the sender.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings.

FIG. 1 is a context diagram of an overall system architecture for categorizing and tagging messages in accordance with embodiments described herein.

FIG. 2 illustrates a system diagram of a message categorization and tagging system in accordance with embodiments described herein.

FIG. 3 illustrates a system diagram of a message classification system in accordance with embodiments described herein.

FIG. 4 is a logical flow diagram showing one embodiment of a process for tagging message senders in accordance with embodiments described herein.

FIG. 5 is a logical flow diagram showing one embodiment of an offline process for tagging message senders in accordance with embodiments described herein.

FIG. 6 is a logical flow diagram showing one embodiment of a process for performing message content clustering in accordance with embodiments described herein.

FIG. 7 is a logical flow diagram showing one embodiment of a process for employing a deep learning network to classify messages in accordance with embodiments described herein.

FIG. 8 is a logical flow diagram showing one embodiment of an inline process for tagging messages in accordance with embodiments described herein.

FIG. 9 is a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including, but not limited to, the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive, and allows for being based on additional features, functions, aspects, or limitations not described, unless the context clearly dictates otherwise. In addition, throughout the specification, the meaning of “a,” “an,” and “the” include singular and plural references.

The following is a brief introduction to messaging platform communications. In general, messages can be peer-to-peer (“P2P”)(e.g., from a first personal communication device to a second personal communication device), application-to-person (“A2P”)(e.g., from an application server to a personal communication device that has a corresponding application installed thereon), or machine-to-machine (“M2M”)(e.g., from one non-personal device to another non-personal device, such as with Internet-of-Things devices). Messages sent from a first device associated with a first messaging platform to a second device associated with a distinct second messaging platform (e.g., a textual message sent from a Verizon subscriber to a T-Mobile subscriber or a textual message sent from a social-media-application server to a Verizon subscriber) may or may not be delivered by either or both of those two messaging platforms alone. For example, some P2P messages are carrier to carrier. However, some over-the-top service providers can also send and receive messages. In some scenarios, over-the-top service providers can connect and transmit messages with carriers either directly or through an interconnect vendor. In A2P and M2M messages, additional entities are often utilized in sending and receiving messages, which may include one or more carriers, over-the-top service providers, aggregators, brand or enterprise computing devices, etc.

In order to improve the routing of messages between messaging platforms, messages are often provided from the originating messaging platform to a message transport platform provider for forwarding to the destination messaging platform, which in turn handles delivery of the messages to the intended destination device within that destination messaging platform. In certain scenarios, the message transport platform may provide additional functionality, such as determining the correct destination messaging platform, appropriately decoding the message as provided by the originating messaging platform, and appropriately encoding the message for provision to the destination messaging platform.

Embodiments described herein can be implemented by one or more entity computing devices, systems, networks, or platforms that are utilizes to handle or forward messages between a sender device and a recipient device, including: carriers, interconnect vendors, over-the-top service providers, aggregators, or the like. Such embodiments enable entities to monitor and manage messaging traffic on their corresponding platforms.

The present disclosure is directed to techniques for providing additional functionality related to processing intra- and inter-platform messages, such as by analyzing message content and other characteristics of such messages to identify the classification of individual messages or clusters of similar messages to determine appropriate (and possibly platform-specific) categories or actions to perform based on the analyzed message. In some embodiments, an entity can take various actions with respect to messages associated with identified message clusters based on configuration information associated with an originating messaging platform, a destination messaging platform, another message transportation platform, or some combination thereof. For example, in certain embodiments, a group of multiple messages may be identified as a message cluster comprising one or more categories of spam; comprising particular categories of enterprise messages (such as two-factor authentication messages, service-to-device or device-to-service messages, account information, advertising, etc.); or other categories.

Depending on the determined categorization for a message or message cluster, in certain embodiments, messages of an identified message cluster may be prioritized over those of another identified message cluster; may be tagged or otherwise modified in accordance with one or more determined categories before messages of the identified message cluster are forwarded to a destination messaging platform, such as to identify the determined categories for use in handling of the messages by the destination messaging platform; blocked from being sent; or otherwise differentiated with respect to other messages that are not in the identified message cluster. Likewise, depending on the determined categorization for an individual message, such messages may be prioritized over other messages associated with other categories; tagged or otherwise modified in accordance with the determined categorization before the messages are forwarded to a destination messaging platform; or otherwise differentiated with respect to other messages associated with other categories.

As used herein, the terms “messaging platform” or “message processing provider” or “message processing entity” as used herein may be used interchangeably and refer to an entity or computing system that facilitates the reception, forwarding, processing, or dissemination of messages between an originating device and a destination device. Such messaging platforms may include carrier networks or non-carrier networks (e.g., service providers, aggregators, company or brand computing devices, or other entities). In some embodiments, a messaging platform may be a private network associated with a carrier, such as may be used by that carrier to provide its telephony, data transmission, and messaging services (e.g., in P2P communications). In other embodiments, the messaging platform may be a computing device or system that can generate or send messages to other computing devices (e.g., in M2M communications or in A2P communications). It will be appreciated that depending on the identities and affiliations of a message originating device and the intended message destination device associated with a given intra- or inter-platform communication, messaging platforms may operate as an originating messaging platform, a destination messaging platform, or an intermediate forwarding messaging platform, or a combination thereof, at any time. Messaging platforms can therefore include one or more private networks, one or more public networks, or some combination thereof. In various embodiments, the originating or destination device may be “mobile subscribers,” such as in the case where a messaging transport platform (e.g., a customer of the Message Categorization and Tagging System) is itself a Mobile Network Operator and the message analyzed by the Message Categorization and Tagging System is then delivered directly to its mobile subscriber. One non-limiting example may be where an entity (e.g., Google) has a direct connection to submit messages to a carrier (e.g., Verizon), where the carrier is using the Message Categorization and Tagging System for its capabilities and then delivering the message to one of its subscribers.

As used herein, the term “carrier” refers to a provider of telecommunication services (e.g., telephony, data transmission, and messaging services) to its client subscribers. Non-limiting examples of such carriers operating within the United States may include Verizon Wireless, provided mainly by Verizon Communications Inc. of Basking Ridge, N.J.; AT&T Mobility, provided by AT&T Inc. of DeKalb County, Ga.; Sprint, provided by Sprint Nextel Corporation of Overland Park, Kans.; T-Mobile, provided by Deutsche Telecom AG of Bonn, Germany; Facebook and/or Facebook messenger, provided by Facebook Inc. of Menlo Park, Calif.; Twitter, provided by Twitter Inc. of San Francisco, Calif.; WhatsApp, provided by WhatsApp Inc. of Menlo Park, Calif.; Google+, provided by Google Inc. of Mountain View, Calif.; SnapChat, provided by Snap Inc. of Venice, Calif., and the like.

The term “message” as used herein refers to textual, multimedia, or other communications sent by a sender to a recipient, and may be used interchangeably with respect to “communication” herein unless context clearly dictates otherwise. The sender or recipient of a message may be a person, a machine, or an application, and may be referred to as the originating device and the destination device, respectively. Thus, messages may be communications sent by one person to another person, communications sent by a person to a machine or application, communications sent by a machine or application to a person, or a communications sent by a machine or application to another machine or application. Non-limiting examples of transmission types for such communications include SMS (Short Message Service), MMS (Multimedia Messaging Service), GPRS (General Packet Radio Services), SS7 messages, SMPP (Short Message Peer-to-Peer) social media, Internet communications, firewall messaging traffic, RCS (Rich Communication Services), or other messages. The term “person” as used herein refers to an individual human, a group, an organization, or other entity. In some example embodiments, messages may include messaging traffic from firewalls, such that the Message Categorization and Tagging System described herein can be used to analyze this traffic (especially traffic blocked by Firewalls) to determine if blocked content could be authorized (where acceptable) and converted to monetizable traffic. As another example embodiment, messages may include RCS messages, where the Message Categorization and Tagging System described herein can be utilized to support analysis of message characteristics and content, such as to analyze chatbot-like automated, contextual responses and messages (e.g., by employing machine learning to train the Message Categorization and Tagging System with known chatbot responses).

The term “customer environment” or “customer platform” or “customer computing device” as used herein may be used interchangeably and refer to an entity associated with the reception, transmission, or dissemination of messages between an originating device associated with a originating messaging platform and a destination device associated with a destination messaging platform, where the customer utilizes a Message Categorization and Tagging System, as described herein, to classify and manage message transmissions and associated transmission information. Accordingly, the customer may be a carrier, the originating messaging platform, the destination messaging platform, an aggregator, over-the-top service providers, brand, enterprise, the originating device of a message, or other messaging platform or entity that is utilizing the Message Categorization and Tagging System described herein. Such entities may be referred to as “users,” “customers,” or “clients” of the Message Categorization and Tagging System or the messaging transport platform, as described herein.

The term “user” as used herein refers to a person, individual, group entity, organization, or messaging platform interacting with the Message Categorization and Tagging System that is used or implemented by a customer environment, including past, future or current users of such a system. Reference herein to a “user” without further designation may therefore include a single person, a group of affiliated persons, or other entity and may include the computing device used by such a user. In various embodiments, the user may also be referred to as a customer.

The term “message device identifier” as used herein refers to a unique identifier of a message originating device or a message destination device. The message device identifier may be a mobile device number (MDN), an Internet Protocol (IP) address, a media access control (MAC) address, or some other unique identifier. Thus, the message device identifier may be a sequence of digits, characters, or symbols assigned to a particular device or entity for data transmission via messaging platforms or other communications network(s).

A “P2P” or “peer-to-peer” message as used herein describes communications sent from a person to one or more other persons, and may in certain scenarios be contrasted with an “application-to-person” or “A2P” message sent to one or more persons and initiated by any automated or semi-automated facility, such as a hardware- or software-implemented system, component, or device. Typical but non-limiting examples of P2P messages include messages between individual persons of messaging platforms (e.g., “Hi Mom”); authorized promotional offers; non-authorized commercial solicitation (i.e., “spam”); etc. Typical but non-limiting examples of A2P messages include social media application messages, video game or other application messages, promotional offers; spam; device updates; alerts and notifications; two-factor authentication; etc. In addition, “machine-to-machine” or “M2M” messages as used herein include messages sent between automated facilities (such as “IoT” or “Internet of Things” communications), and may in certain scenarios and embodiments be used interchangeably to describe “application-to-application” or “A2A” communications. Typical but non-limiting examples of M2M messages include device updates; alerts and notifications, and certain instances of two-factor authentication. It will be appreciated from the examples above that P2P, A2P, and M2M message types are not mutually exclusive; various categories of communications may be appropriately associated with multiple such message types.

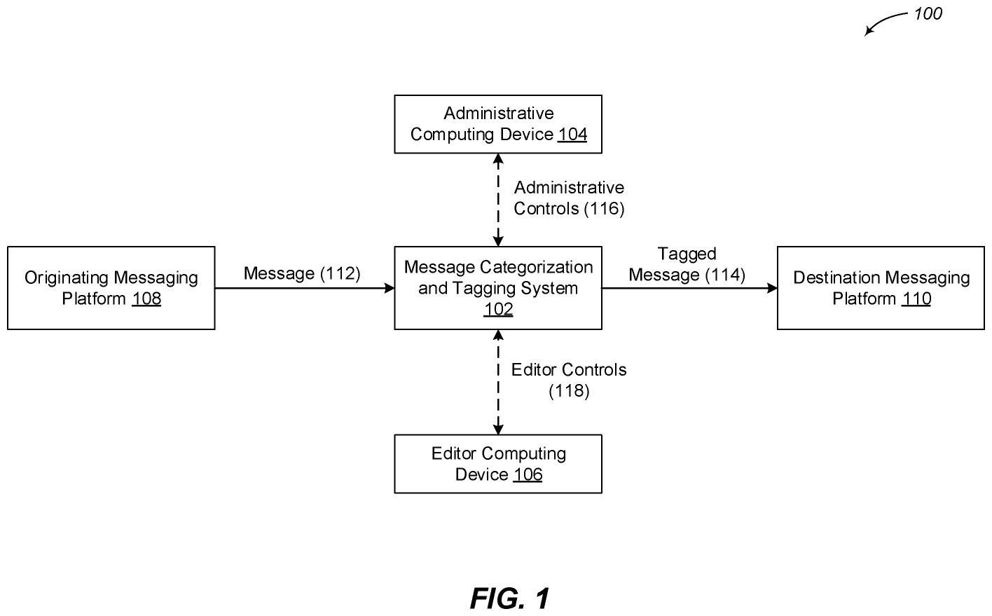

FIG. 1 is a context diagram of an overall system 100 architecture for categorizing and tagging messages in accordance with embodiments described herein. System 100 includes a message categorization and tagging system 102, an originating messaging platform 108, and a destination messaging platform 110. In some embodiments, the system 100 also includes one or more administrative computing devices 104 and one or more editor computing devices 106.

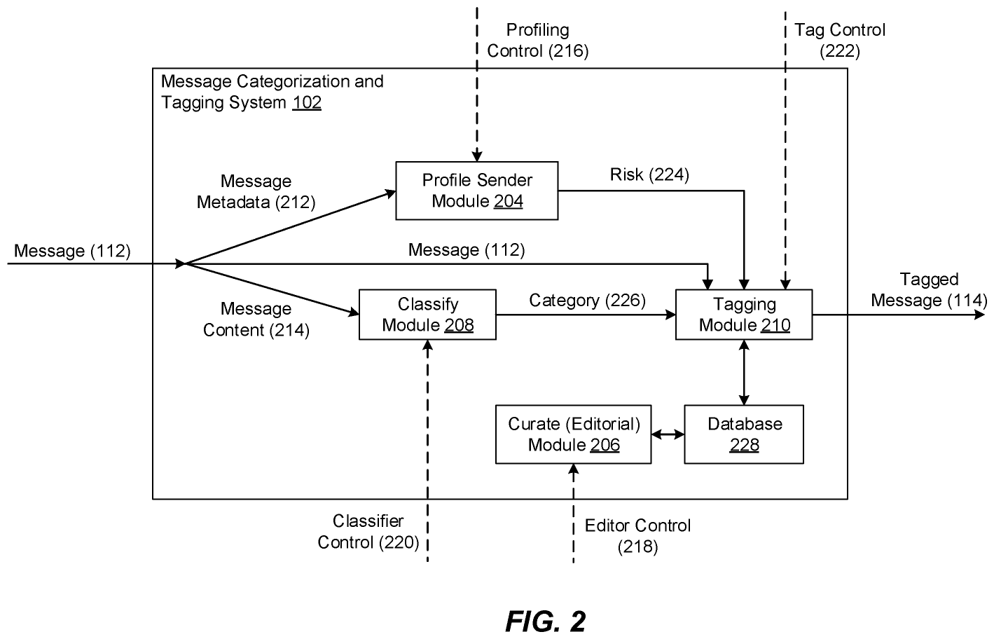

The message categorization and tagging system 102, which may also be referred to as a message processing system, is described in more detail below in conjunction with FIG. 2. Briefly, however, the message categorization and tagging system 102 receives a stream of one or more messages 112 from the originating messaging platform 108, tags each separate message with a category and a spam risk value, and outputs the tagged message(s) 114 to the destination messaging platform 110. Although the message categorization and tagging system 102 is illustrated as being separate from the originating messaging platform 108 and the destination messaging platform 110, embodiments are not so limited. In some embodiments, the message categorization and tagging system 102 may be embedded in, part of, or utilized by the originating messaging platform 108 to analyze messages 112 prior to transmitting the messages 112 from the originating messaging platform 108 to the destination messaging platform 110. In other embodiments, the message categorization and tagging system 102 may be embedded in, part of, or utilized by the destination messaging platform 110 to analyze messages 112 received from the originating messaging platform 108 prior to transmitting the messages 112 to a destination device (not illustrated).

The originating messaging platform 108 is an entity or computing system that facilitates the reception and forwarding of messages from an originating device. In some embodiments, the originating messaging platform 108 may represent a message stream, file, or other source of a message 112. The messaging platform destination 110 is an entity or computing system that facilitates the reception and forwarding of messages from to a destination device. In some embodiments, the messaging platform destination 110 may be a database, file, or other place where information related to a tagged message 114 can be stored.

The message 112 includes content and metadata. The message metadata may include various information related to the message or the content of the message, including message identifier, message originating device identifier (e.g., sending phone number), message destination device identifier (e.g., destination phone number), or other information collected by the originating messaging platform, carrier, or other, telecom provider related to the message, the sender, or the recipient. Although message 112 is illustrated as a single message, embodiments are not so limited. In other embodiments, the message categorization and tagging system 102 may receive a plurality of messages 112 from one or more originating messaging platforms 108, tag each of the plurality of messages (tagged messages 114), and forwarded the tagged messages to one or more destination messaging platforms 110.

The message categorization and tagging system 102 may also communicate with an administrative computing device 104. The administrative computing device 104 provides a user interface that enables an administrator or other user to view a dashboard of information relating to the operation of the message categorization and tagging system 102, information relating to messages being tagged by the message categorization and tagging system 102, or otherwise, configure, control, or monitor various parameters associated with the tagging of the message 112. For example, a customer (e.g., a carrier or messaging platform operator) may utilize an administrative computing device 104 to set spam threshold values and view the volume and destinations of spam messages. In various embodiments, the administrative computing device 104 sends one or more administrative controls 116 to the message categorization and tagging system 102, which cause the message categorization and tagging system 102 to modify one or more parameters or to respond with information requested in the administrative controls 116.

The message categorization and tagging system 102 may also communicate with an editor computing device 106. The editor computing device 106 provides a user interface that enables an editor or other user to view a dashboard of information that enables the editor to label data and messages utilized in the training of the message and sender classification mechanisms described herein. In various embodiments, the editor computing device 106 sends one or more editor controls 118 to the message categorization and tagging system 102, which cause the message categorization and tagging system 102 to label data or messages (e.g., by modifying message metadata or adding a label to a database) or to respond with information requested in the editor controls 118 (e.g., a list of labeled data).

FIG. 2 illustrates a system diagram of a message categorization and tagging system 102 in accordance with embodiments described herein. The message categorization and tagging system 102 includes a profile sender module 204, a classify module 208, a tagging module 210, a curate module 206, and a database 228.

A message 112 is received at the message categorization tagging system 102. As mentioned above, the message 112 includes metadata 212 and content 214. The metadata 212 of the message 112 is provided to the profile sender module 204 and the content 214 of the message 112 is provided to the classify module 208. The message 112 itself is also provided to the tagging module 210. As mentioned above, message 112 is illustrated as a single message, but may include a plurality of messages in other embodiments.

The profile sender module 204 determines and updates risk profiles of the sender of the message 112. In various embodiments, the profile sender module 204 determines a risk 224 of whether the sender of the message 112 is a spammer or not, which is described in more detail below. In some embodiments, an administrator may provide profiling controls 216 to the profile sender module 204 to view sender profiles or to modify parameters of the profile sender module 204. In various embodiments, the profiling controls 216 may be provided via the administrative computing device 104 in FIG. 1.

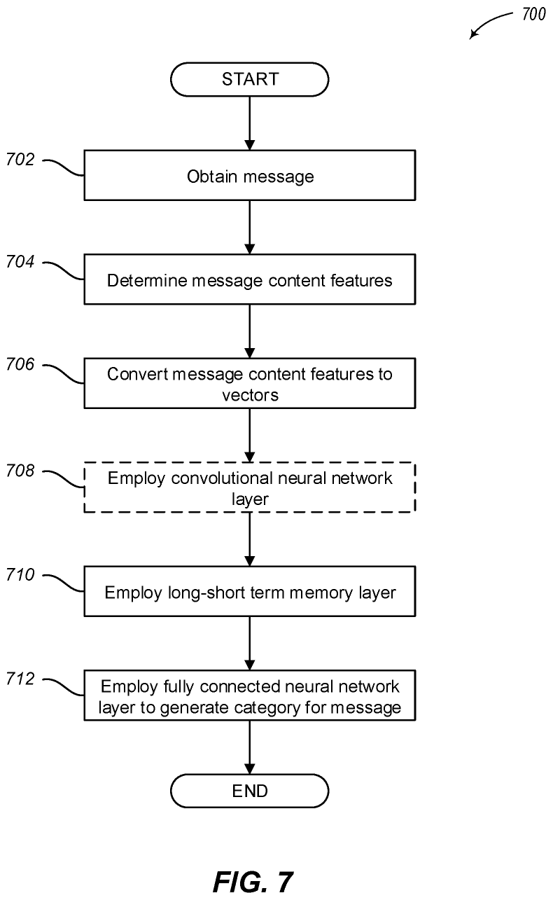

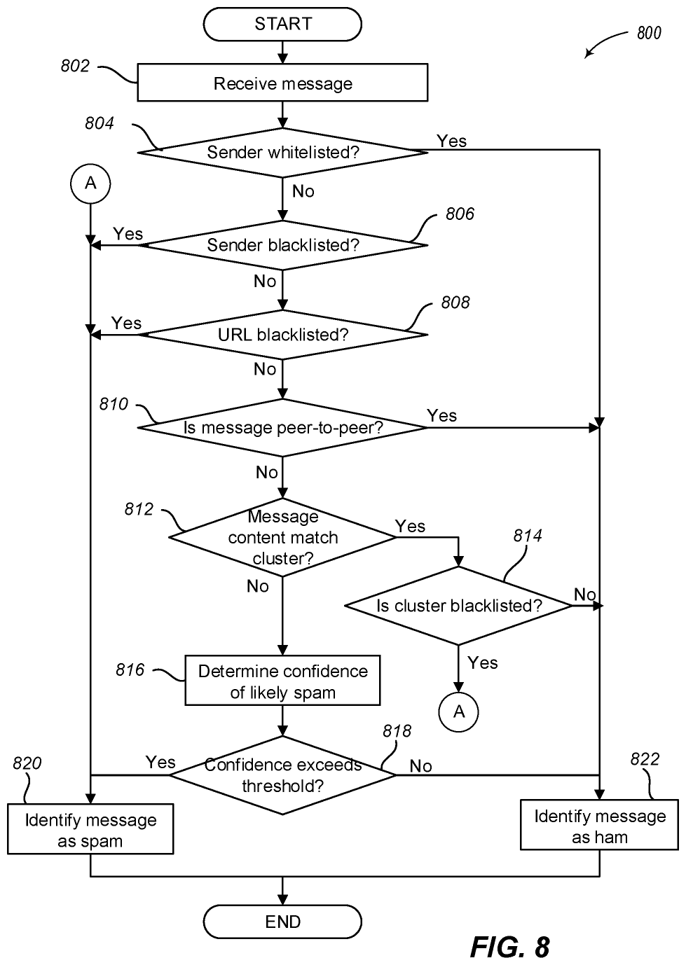

The classify module 208 transforms the message content 214 into one of a plurality of categories 226, which is discussed in more detail below. In some embodiments, these categories are predefined by an administrator, which may be input via classifier controls 220. In other embodiments, the categories are determined by employing a machine learning process on a plurality of training message content to group message content into categories. In various embodiments, the classifier controls 220 may be provided via the administrative computing device 104 in FIG. 1. Example process embodiments of classify module 208 are described below in conjunction with FIGS. 7 and 8.

The curate module 206 enables an editor or other user to label data and messages, as well as to label and categorize message clusters, for use categorizing or tagging messages. In various embodiments, the curate module 206 receives editor controls 218 to perform this labeling, which may be received from the editor computing device 106 in FIG. 1. The labeled data and clusters are stored in a database 228. In various embodiments, the database 228 stores historical and volumetric information on clusters and senders, which can be accessed and viewed by editors.

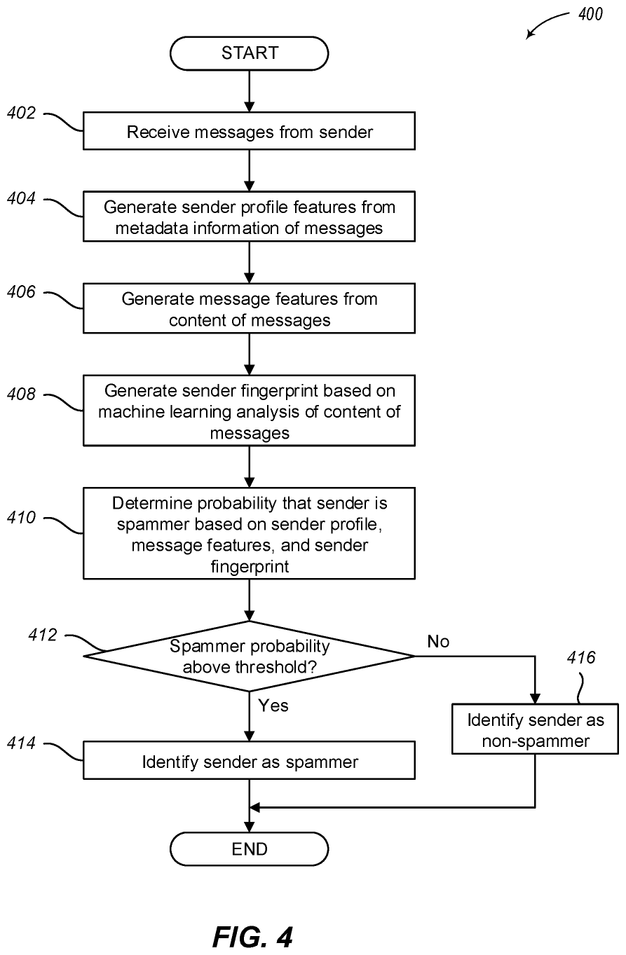

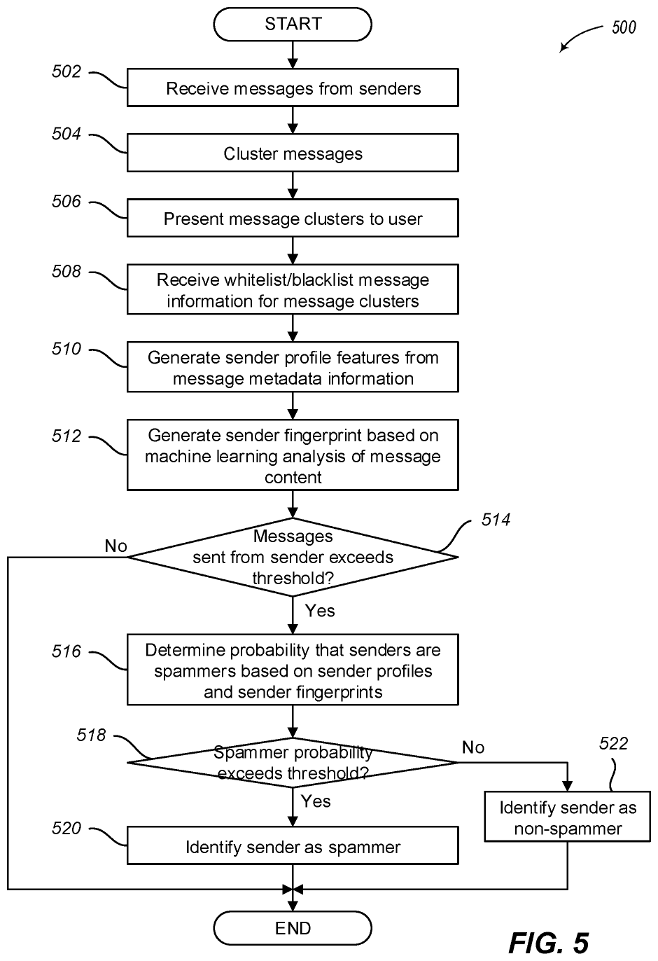

The tagging module 210 receives a determined risk 224 from the profile sender module 204 and a determined category 226 from the classify module 208 for the message 112. The tagging module 210 calculates a probability that the message 112 or the message content 214 includes spam or is sent from a spammer based on the risk 224 and the category 226. In various embodiments, this classification and tagging also utilizes clusters and historical data stored in the database 228. For example, if the category 226 is an advertisement and the risk 224 is low (e.g., a known and legitimate company that sends monthly advertisements), then the message may be tagged as non-spam. However, if the category 226 is an advertisement and the risk 224 is high (e.g., an unknown sender that sends dozens of advertisement messages per hour), then the message may be tagged as spam. In some embodiments, the risk 224 alone or the category 226 alone may be used to tag the message as spam. In other embodiments, a weighted combination of the risk 224 and the category 226 may be used to determine a probability that the message 112 is spam and tagged accordingly. Example process embodiments of tagging module 210 are described below in conjunction with FIGS. 4 and 5.

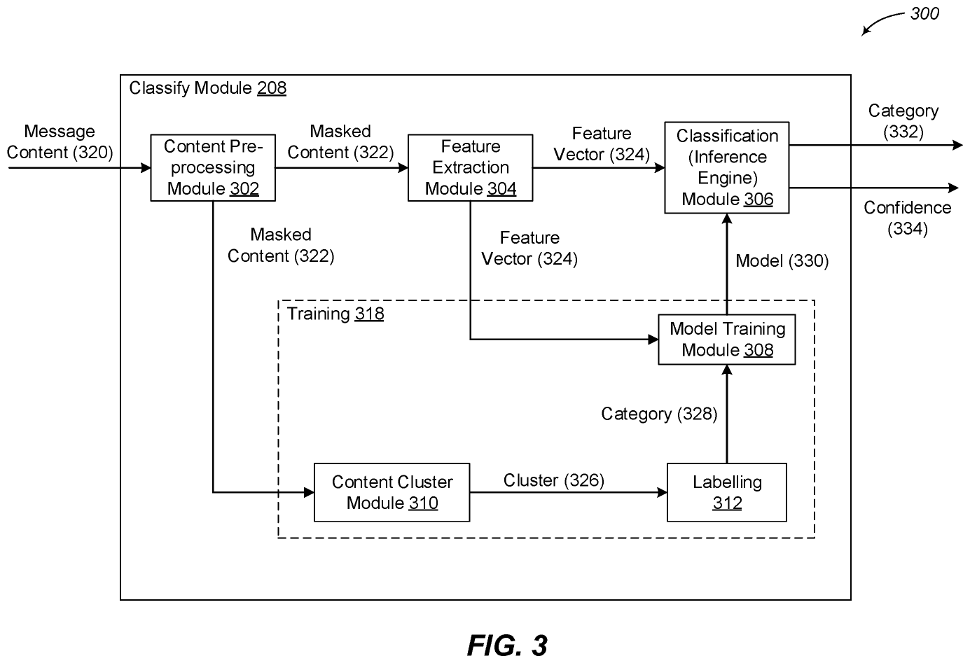

FIG. 3 illustrates a system diagram of a message classification system 300 in accordance with embodiments described herein. As mentioned above, the classify module 208 transforms message content into one of a plurality of categories. Message classification system 300 includes classify module 208 of FIG. 2, which inputs message content 320 (e.g., message content 214 in FIG. 2) and outputs category 332 (e.g., category 226 in FIG. 2) and confidence 334.

The classify module 208 includes a content pre-processing module 302, a feature extraction module 304, a classification module 306, and a training component 318. The content pre-processing module 302 receives and converts the message content 320 into masked content 322. This conversion include message tokenization, lowercasing the message, replacing the special characters, accent removal, stemming, named entity recognition, part of speech tagging, and other word-processing techniques. Message tokenization may be done by replacing the URL, phone numbers, email addresses, numbers, dates, currencies, and other information with associated tokens, which removes personal or non-relevant information, but includes a token to represent the data. The pre-processing module 302 may also calculate other relevant message features, such as number of upper case letters, number of grammar errors, etc.

The feature extraction module 304 transforms the masked content 322 into feature vectors 324. The feature vectors 324 are provided to the classification module 306 as inputs to a classification model to identify the category 332 of the message content 320. The feature vectors 324 are also provided to the model training module 308.

The classification module 306 loads or obtains a model 330 from a model training module 308, inputs the feature vectors 324 into the model 330, and outputs the resulting category 332 and its confidence score 334. In various embodiments, the model 330 is a model trained from historical messages and labels using a deep learning network.

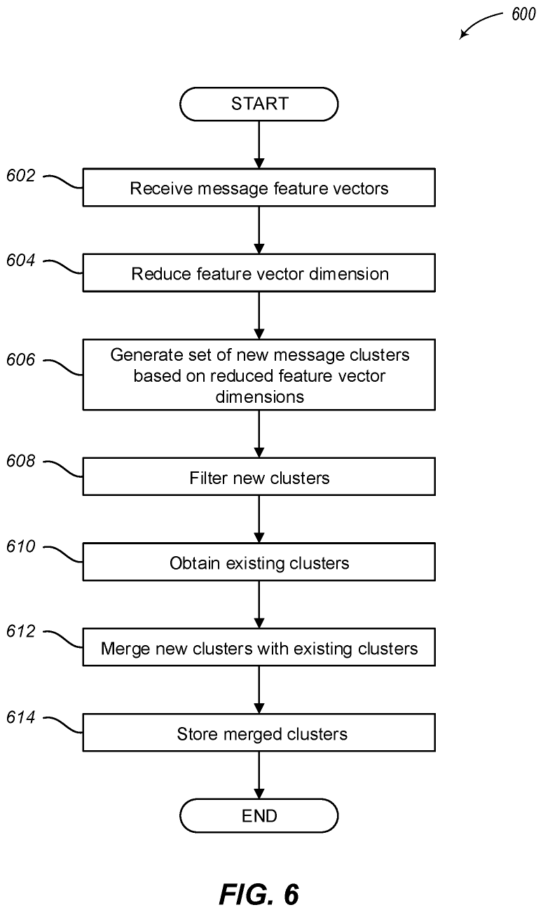

The masked content 322 generated by the content pre-processing module 302 is also provided to a training component 318. The training component 318 includes a content cluster module 310, a model training module 308, and a labeling 312. The masked content 322 is provided to the content cluster module 310, which generates one or more clusters 326 for the masked content 322 using one or more clustering algorithms or methods. Example process embodiments of cluster module 310 are described below in conjunction with FIG. 6. The one or more clusters 326 are provided to labelling 312, where an editorial team assigns a category 328 to the one or more clusters 326. The model training module 308 utilizes the labeled categories 328 and the corresponding the feature vectors 324 to generate the machine learning model 330.

FIG. 4 is a logical flow diagram showing one embodiment of a process 400 for tagging message senders in accordance with embodiments described herein. Process 400 begins, after a start block, at block 402, where a plurality of messages are received from a sender. As described above, the messages may be received from an originating messaging platform 108 en route to a destination messaging platform 110 for delivery to a destination. Each message includes content and corresponding metadata information. The metadata information for a respective message may include various information related to the respective message, including message identifier, sending device identifier, destination device identifier, etc.

Process 400 proceeds to block 404, where sender profile features are generated from metadata information of the received messages. In various embodiments, the sender profile features are obtained by extracting select information from the message metadata information. The extracted information is aggregated over time (e.g., one day, one week, multiple weeks, etc.) to create the separate sender profile features. Examples of the sender profile features may include a number of messages sent by the sender, the rate of messages sent by the sender within a select time period, the ratio between sent and received messages, information regarding existing relationships between the sending and the recipient devices, etc.

In some embodiments, sender profile features may be stored for each unique sending device identifier. In other embodiments, sender profile features may be stored for only those sending device identifiers that meet one or more threshold criteria, which may be set by a user or administrator. For example, the sender profile features may be stored for those sending device identifiers that send more than a threshold number of messages in a given amount of time. As another example, the sender profile features may be stored for those sending device identifiers that have a send/receive ratio that exceeds a threshold value.

Process 400 continues at block 406, where message features are generated from the content of the received messages. In various embodiments, the message features are characteristics of the text, language, or information presented in the content of the messages, which may be aggregated, averaged, or otherwise analyzed across a plurality of messages. For example, message features may include number of uppercase letters per message, percentage of sent messages with different placeholders (e.g., phone numbers, currencies, email addresses, math symbols, special symbols, etc.), number of spelling or grammar errors per message, or other information that can be extracted from the message content.

Process 400 proceeds next to block 408, where a sender fingerprint is generated based on machine learning analysis of the message content. In various embodiments, machine learning may be employed on all messages sent by a sender and aggregated using an average probability from all messages.

Process 400 continues next at block 410, where a probability that the sender is a spammer is determined based on the sender profile, the message features, and the sender fingerprint. In various embodiments, one or more machine learning algorithms may be employed, such as gradient boosting, random forest classifier, or support vector machine, to generate a probability that a sender device identifier is a spammer based on the sender profile features, message features, and sender fingerprint.

Process 400 proceeds to decision block 412, where a determination is made whether the spammer probability exceeds a threshold. In various embodiments, the threshold is set by a user or administrator. If the spammer probability exceeds the threshold, then process 400 flows to block 414; otherwise, process 400 flows to block 416.

At block 414, the sender is identified as a spammer. In some embodiments, identifying the sender as a spammer may include adding the sender's information to a “blacklist” of senders that send spam messages. In other embodiments, a database containing a list of all known senders may be updated to tag the sender as a spammer. After block 414, process 400 terminates or otherwise returns to a calling process to perform other actions.

If, at decision block 412, the spammer probability does not exceed the threshold then process 400 flows from decision block 412 to block 416. At block 416, the sender is identified as a non-spammer. In some embodiments, identifying the sender as a non-spammer may include adding the sender's information to a “whitelist” of senders that do not send spam messages. In other embodiments, a database containing a list of all known senders may be updated to tag the sender as a non-spammer. After block 416, process 400 terminates or otherwise returns to a calling process to perform other actions.

FIG. 5 is a logical flow diagram showing one embodiment of an offline process 500 for tagging message senders in accordance with embodiments described herein.

Process 500 begins, after a start block, at block 502, where a plurality of messages are received from one or more senders.

Process 500 proceeds to block 504, where the messages are clustered. In various embodiments, the messages are clustered based on a type of their content or message features from their content. One example of message clusters may include product advertisements, political advertisements, and religious advertisements. Another example of message clusters, may include messages with URLs, messages with more than 10 misspelled words, and messages with more than 50 characters.

In some embodiments, the clustering of messages may be performed on messages received within a select time period. For example, messages received during a first 10 minute time period are clustered based on their content. At the end of the first 10 minute time period, a second 10 minute time period begins, such that messages received during the second 10 minute time period are clustered. In various embodiments, the message clusters are merged with previously determined and stored message clusters.

Additional embodiments and details of clustering messages is discussed in more detail below in conjunction with FIG. 6.

Process 500 continues at block 506, where the message clusters are presented to one or more users, such as an editorial team. In various embodiments, a user interface may be provided to the users to enable the user to select which message clusters are spam, ham, or unknown.

Process 500 proceeds next at block 508, where whitelist and blacklist information is received for the message clusters. In various embodiments, a user may identify a particular message cluster relating to a phishing scam disguised as a product advertisement as spam. This user may select, via the user interface, to blacklist this message cluster. As another example, the user may identify a particular message cluster as a legitimate product advertisement and select to whitelist this message cluster.

In some other embodiments, the user interface may enable the user to select particular information or content from a message cluster to whitelist or black list. For example, the user can select a particular URL or phrase from a message cluster to whitelist or blacklist.

Process 500 continues next at block 510, where sender profile features are generated from the metadata information for each message. In various embodiments, block 510 may employ embodiments of block 404 in FIG. 4 to generate the sender profile features.

Process 500 proceeds to block 512, where sender fingerprints are generated for the senders based on machine learning analysis of message content. In various embodiments, block 512 may employ embodiments of block 408 in FIG. 4 to generate the sender fingerprint.

Process 500 continues to decision block 514, where a determination is made whether a number of messages from a sender exceeds a threshold. For each sender that sent a number of messages that exceeded the threshold, process 500 flows to block 516; otherwise, the other senders are not further analyzed and process 500 terminates or otherwise returns to a calling process to perform other actions. In some embodiments, if a sender sent a number of messages that did not exceed the threshold, then process 500 flows (not illustrated) to block 522 to identify the sender as a non-spammer.

If a sender sent a number of messages that exceeded the threshold at decision block 514, process 500 flows from decision block 514 to block 516. At block 516, a probability that the sender is a spammer is determined based on the sender profiles and the sender fingerprints. In various embodiments, block 512 may employ embodiments of block 410 in FIG. 4 to determine a probability that the sender is a spammer.

Process 500 proceeds next to decision block 518, where a determination is made whether the spammer probability exceeds a threshold. In various embodiments, decision block 518 may employ embodiments of decision block 412 in FIG. 4 to determine if the spammer probability exceeds a selected threshold. If the spammer probability exceeds the threshold, then process 500 flows to block 520; otherwise, process 500 flows to block 522.

At block 520, the sender is identified as a spammer. In some embodiments, block 520 employs embodiments of block 414 in FIG. 4 to identify the sender as a spammer. After block 520, process 500 terminates or otherwise returns to a calling process to perform other actions.

If, at decision block 518, the spammer probability is not exceeded the threshold then process 500 flows from decision block 518 to block 522 to identify the sender as a non-spammer. In various embodiments, block 522 employs embodiments of block 416 in FIG. 4 to identify the sender as a non-spammer. After block 522, process 500 terminates or otherwise returns to a calling process to perform other actions.

FIG. 6 is a logical flow diagram showing one embodiment of a process 600 for performing message content clustering in accordance with embodiments described herein. Process 600 begins, after a start block, at block 602, where message feature vectors are received. In various embodiments, the message feature vectors may be generated from the message features generated at block 406 in FIG. 4.

Process 600 proceeds to block 604, where the feature vector dimension is reduced. In various embodiments, principal component analysis, or other dimensionality reduction method, may be employed on the message feature vectors to reduce a number of feature vector dimensions.

Process 600 continues at block 606, where a set of new message clusters are generated based on the reduced feature vector dimensions. In various embodiments, the message content may be clustered based on spatial partitioning trees or other clustering algorithms. In other embodiments, messages may be clusters using keywords and techniques, such as term frequency-inverse document frequency.

Process 600 proceeds next to block 608, where new clusters are filtered. In various embodiments, the new clusters are filtered based on their size with clusters having a number of messages that exceeds a select threshold number or percentage being maintained and the other clusters that do not exceed the threshold being ignored or discarded.

In some embodiments, a cluster representative message may be selected for each cluster. The cluster representative message of a given cluster may be defined as an average of all message feature vectors of messages associated with the given cluster.

Process 600 continues next at block 610, where existing clusters are obtained from a database. In various embodiments, existing clusters may be stored for a select time period, from a specific sender or group of senders, or until no messages are received for a cluster in a threshold amount of time.

Process 600 proceeds to block 612, where the new clusters are merged with the existing clusters. In various embodiments, spatial partitioning tree structures, such as kd-tree, r-tree, or balltree algorithms, may be employed to merge the new clusters with the existing clusters.

Process 600 continues at block 614, where the merged clusters are stored.

After block 614, process 600 terminates or returns to a calling process to perform other actions.

FIG. 7 is a logical flow diagram showing one embodiment of a process 700 for employing a deep learning network to classify messages in accordance with embodiments described herein. Process 700 begins, after a start block, at block 702, where a message is obtained. As described above, the message may be received from an originating messaging platform 108 en route to a destination messaging platform 110 for delivery to a destination. The message may include content and corresponding metadata information.

Process 700 proceeds to block 704, where message content features for the message are determined. In various embodiments, block 704 may employ embodiments of block 406 in FIG. 4 to generate message content features.

Process 700 continues at block 706, where the message content features are converted to vectors. In various embodiments, block 706 may employ embodiments of block 602 to receive or generate message feature vectors.

In various embodiments, the message content features may be converted into predefined dimensions. In some embodiments, character-level processing may be employed to convert characters to vectors. In other embodiments, word-level processing may be employed to convert words to vectors. In various embodiments, these feature vector conversion may be learned using training data or predefined word representations.

Process 700 proceeds next to block 708, where a convolution neural network layer is employed on the message-content-feature vectors. In at least one embodiment, block 708 may be optional, and may not be performed. In some embodiments, the convolution neural network layer may be replaced with other machine learning methods, such as random forest classifier, support vector machine, gradient boosting, etc.

Process 700 continues next at block 710, where long-short term memory layer is employed. In some embodiments, one or more Gated Recurrent Unit layers may be deployed instead of one or more long-short term memory layers.

Process 700 proceeds to block 712, where a fully connected neural network is employed on the message-content-feature vectors to generate a category associated with the message.

After block 712, process 700 terminates or returns to a calling process to perform other actions.

FIG. 8 is a logical flow diagram showing one embodiment of an inline process 800 for tagging messages in accordance with embodiments described herein. In various embodiments, process 800 may be employed as an inline process for spam classification, which blocks or releases messages directly in a user environment.

Process 800 begins, after a start block, at block 802, where a message is received. In various embodiments, block 802 may employ embodiments of block 702 to receive or obtain a message.

Process 800 proceeds to decision block 804, where a determination is made whether the sender of the message is whitelisted. In various embodiments, the sending device identifier is compared to a list of whitelisted device identifiers. If the sender is whitelisted, then process 800 flows to block 822, where the message is identified as “ham” or non-spam; otherwise, process 800 flows to decision block 806.

At decision block 806, a determination is made whether the sender of the message is blacklisted. In various embodiments, the sending device identifier is compared to a list of blacklisted device identifiers. If the sender is blacklisted, then process 800 flows to block 820, where the message is identified as spam; otherwise, process 800 flows to decision block 808.

At decision block 808, a determination is made whether the message contains a URL that is blacklisted. In various embodiments, the message content features may be obtained and analyzed. If a message content feature includes a URL, the URL may be compared to a list of blacklisted URLs. If the message contains a blacklisted URL, then process 800 flows to block 820, where the message is identified as spam; otherwise, process 800 flows to decision block 810.

At decision block 810, a determination is made whether the message is peer-to-peer. In some embodiments, a list of known personal device identifiers may be stored. The sending device identifier and destination device identifier of the message are compared to the list of known personal device identifiers. If both identifiers are in the list, then the message is identified as peer-to-peer. If the message is peer-to-peer, then process 800 flows to block 822, where the message is identified as ham; otherwise, process 800 flows to decision block 812.

At decision block 812, a determination is made whether the message content matches a previously identified or defined cluster. In various embodiments, the message-content-feature vectors of the message are compared to the cluster representative messages of a plurality of previously stored clusters. If the message-content-feature vectors match a cluster representative message of a given cluster, then the message matches that given cluster. If the message content matches a cluster, then process 800 flows to decision block 814; otherwise, process 800 flows to block 816.

At decision block 814, a determination is made whether the cluster matching the message content is blacklisted. In various embodiments, the cluster is compared to a list of blacklisted clusters. If the cluster is blacklisted, then process 800 flows to block 820, where the message is identified as spam; otherwise, process 800 flows to block 822, where the message is identified as ham.

If, at decision block 812, the message content does not match a cluster, then process 800 flows from decision block 812 to block 816. At block 816, a confidence of whether the message is likely spam is determined. In various embodiments, a spam model that outputs a confidence that the message is spam and should be blocked. In various embodiments, block 816 may employ embodiments similar to those described in conjunction with process 400 in FIG. 4, but for a specific message.

Process 800 proceeds to decision block 818, where a determination is made whether the determined spam confidence exceeds a threshold. If the confidence exceeds a threshold, then process 800 flows to block 820, where the message is identified as spam; otherwise, process 800 flows to block 822, where the message is identified as ham.

At block 820, where the message is identified as spam, the message may be blocked from further forwarding to the destination. In some embodiments, the message may be further processed to reinforce or retrain the spam models described herein.

At block 822, where the message is identified as ham, the message may be forwarded to the destination.

After block 820 and block 822, process 800 terminates or otherwise returns to a calling process to perform other actions. In some embodiments, process 800 may loop (not illustrated) to block 802 to receive another message.

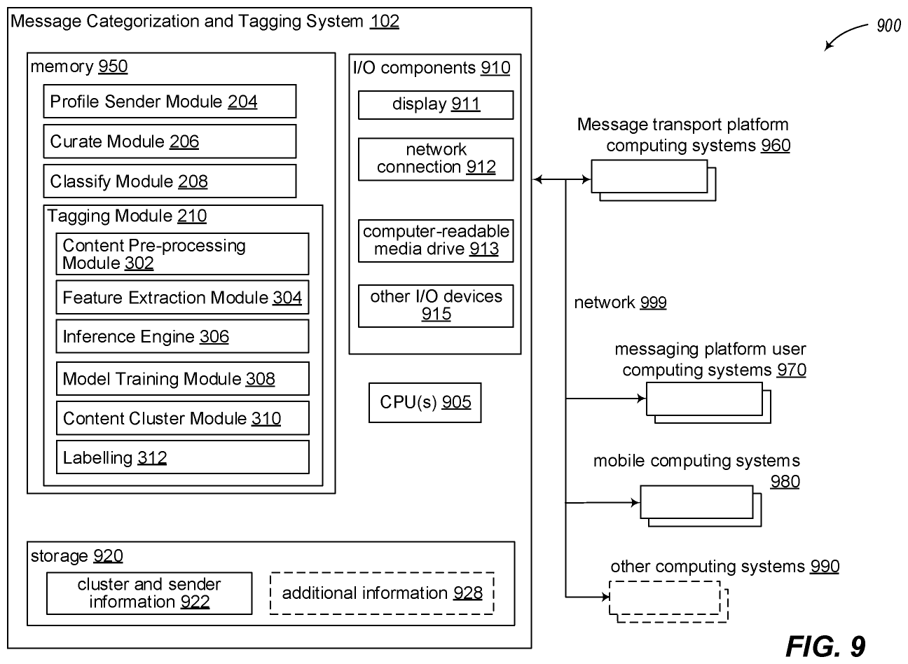

FIG. 9 is a system diagram that describes one implementation of computing systems for implementing embodiments described herein. The message categorization and tagging system 102 may be implemented using a plurality of circuits that, when in combined operation, are suitable for performing and configured to perform at least some of the techniques described herein. Accordingly, various embodiments described herein may be implemented in software, hardware, firmware, or in some combination thereof. In the illustrated embodiment, message categorization and tagging system 102 includes one or more hardware central processing units (“CPU”) or other processors 905, various input/output (“I/O”) components 910, storage 920, and non-transitory memory 950. The illustrated I/O components may include a display 911, a network connection 912, a computer-readable media drive 913 (e.g., stationary or removable computer-readable media, such as removable flash drives, external hard drives, or the like.), and other I/O devices 915 (e.g., keyboards, mice or other pointing devices, microphones, speakers, GPS receivers, etc.).

Memory 950 may include one or more various types of non-volatile and/or volatile storage technologies. Examples of memory 950 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 950 may be utilized to store information, including computer-readable instructions that are utilized by CPU 905 to perform actions, including embodiments described herein.

Memory 950 may have stored thereon the profile sender module 204, the curate module 206, the classify module 208, and the tagging module 210, which, when executed, perform embodiments described herein. The tagging module 210 includes a content pre-processing module 302, feature extraction module 304, classification module or inference engine 306, model training module 308, content cluster module 310, and the labeling 312, which, when executed, perform embodiments described herein.

The message categorization and tagging system 102 may also include a storage 920, which may store cluster and sender information 922 and optionally additional information 928. The cluster and sender information 922 may store previously determined clusters, sender profiles, whitelist information, blacklist information, machine learning models, or other information

In the illustrated embodiment, an embodiment of the message categorization and tagging system 102 executes in memory 950 in order to perform at least some of the described techniques, such as by using the processor(s) 905 to execute software instructions of the message categorization and tagging system 102 in a manner that configures the processor(s) 905 to perform automated operations that implement those described techniques. As part of such automated operations, the message categorization and tagging system 102 and/or other optional programs or modules executing in non-transitory memory 950 may store and/or retrieve various types of data, including in the example database data structures of storage 920.

The message categorization and tagging system 102 may communicate via network connection 912 and one or more networks 999 (e.g., the Internet, one or more cellular telephone networks, etc.) with other computing systems, such as message transport platform computing systems 960, messaging platform user computing systems 970, mobile computing systems 980, and other computing systems 990. Some or all of the other computing systems may similarly include some or all of the types of components illustrated for the message categorization and tagging system 102.

The various embodiments described above can be combined to provide further embodiments. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, by one or more computing systems, a plurality of messages from a sender, each of the plurality of messages includes metadata and content;
generating, by the one or more computing systems, a sender profile for the sender based on an analysis of the metadata of each of the plurality of messages;
classifying, by the one or more computing systems, each respective message of the plurality of messages as one of a plurality of categories based on a deep learning network analysis of the content of each respective message;
generating, by the one or more computing systems, a sender fingerprint based on a machine learning analysis of the content of each respective message;
determining, by the one or more computing systems, a probability that the sender is a spammer based on the sender profile, the message classifications, and the sender fingerprint; and
tagging, by the one or more computing systems, the sender based on the determined probability.

2. The method of claim 1, further comprising:
clustering, by the one or more computing systems, the plurality of messages into a plurality of clusters based on the content; and
determining, by the one or more computing systems, whether one or more of the plurality of clusters is associated with a whitelisted or blacklisted cluster.

3. The method of claim 2, wherein clustering the plurality of messages includes:
generating message feature vectors based on the content of each respective message;
generating new message clusters based on the message feature vectors; and
merging the new message clusters with a plurality of existing message clusters.

4. The method of claim 2, wherein clustering the plurality of messages includes:
generating message feature vectors based on the content of each respective message; and
employing a spatial partitioning tree using the message feature vectors to generate the plurality of clusters.

5. The method of claim 1, wherein classifying the plurality of messages includes:
generating message feature vectors based on the content of each respective message;
employing one or more convolution neural network layers on the message feature vectors;
employing one or more long-short term memory layers on the message feature vectors; and
employing one or more fully connected neural network layers on the message feature vectors to determine a category for each respective message.

6. The method of claim 1, wherein generating the sender profile for the sender includes:
aggregating information obtained from the plurality of messages regarding the sender.

7. A non-transitory computer-readable medium having stored contents that, when executed by one or more computing systems, cause the one or more computing systems to:
receive a plurality of messages from a sender, each of the plurality of messages includes metadata and content;
generate a sender profile for the sender based on an analysis of the metadata of each of the plurality of messages;
classify each respective message of the plurality of messages as one of a plurality of categories based on a deep learning network analysis of the content of each respective message;
generate a sender fingerprint based on a machine learning analysis of the content of each respective message;
determine a probability that the sender is a spammer based on the sender profile, the message classifications, and the sender fingerprint; and
tag the sender based on the determined probability.

8. The non-transitory computer-readable medium of claim 7, wherein the stored contents further cause the one or more computing systems to:
cluster the plurality of messages into a plurality of clusters based on the content; and
determine whether one or more of the plurality of clusters is associated with a whitelisted or blacklisted cluster.

9. The non-transitory computer-readable medium of claim 8, wherein to cluster the plurality of messages includes:
generate message feature vectors based on the content of each respective message;
generate new message clusters based on the message feature vectors; and
merge the new message clusters with a plurality of previous message clusters.

10. The non-transitory computer-readable medium of claim 8, wherein to cluster the plurality of messages includes:
generate message feature vectors based on the content of each respective message; and
employ a spatial partitioning tree using the message feature vectors to generate the plurality of clusters.

11. The non-transitory computer-readable medium of claim 7, wherein to classify the plurality of messages includes:
generate message feature vectors based on the content of each respective message;
employ one or more convolution neural network layers on the message feature vectors;
employ one or more long-short term memory layers on the message feature vectors; and
employ one or more fully connected neural network layers on the message feature vectors to determine a category for each respective message.

12. The non-transitory computer-readable medium of claim 7, wherein to generate the sender profile for the sender includes:
aggregate information obtained from the plurality of messages regarding the sender.

13. A system, comprising:
one or more processors; and
at least one non-transitory memory, the non-transitory memory including instructions that, upon execution by at least one of the one or more processors, cause the system to:
receive a plurality of messages from a sender, each of the plurality of messages includes metadata and content;
generate a sender profile for the sender based on an analysis of the metadata of each of the plurality of messages;
classify each respective message of the plurality of messages as one of a plurality of categories based on a deep learning network analysis of the content of each respective message;
generate a sender fingerprint based on a machine learning analysis of the content of each respective message;
determine a probability that the sender is a spammer based on the sender profile, the message classifications, and the sender fingerprint; and
tag the sender based on the determined probability.

14. The system of claim 13, wherein the instructions further cause the system to:
cluster the plurality of messages into a plurality of clusters based on the content; and
determine whether one or more of the plurality of clusters is associated with a whitelisted or blacklisted cluster.

15. The system of claim 14, wherein to cluster the plurality of messages includes:
generate message feature vectors based on the content of each respective message;
generate new message clusters based on the message feature vectors; and
merge the new message clusters with a plurality of previous message clusters.

16. The system of claim 14, wherein to cluster the plurality of messages includes:
generate message feature vectors based on the content of each respective message; and
employ a spatial partitioning tree using the message feature vectors to generate the plurality of clusters.

17. The system of claim 13, wherein to classify the plurality of messages includes:
generate message feature vectors based on the content of each respective message;
employ one or more convolution neural network layers on the message feature vectors;
employ one or more long-short term memory layers on the message feature vectors; and
employ one or more fully connected neural network layers on the message feature vectors to determine a category for each respective message.

18. The system of claim 13, wherein to generate the sender profile for the sender includes:
aggregate information obtained from the plurality of messages regarding the sender.
